(19) United States
(12) Patent Application Publication
(10) Pub. No.: US 2026/0156600 A1
(43) Pub. Date: Jun. 4, 2026

(54) USER EQUIPMENT MOBILITY BETWEEN NON-TERRESTRIAL NETWORK AND TERRESTRIAL NETWORK

(71) Applicant: Google LLC, MOUNTAIN VIEW, CA (US)

(72) Inventors: Ming-Hung TAO, Taoyuan City (TW); Chih-Hsiang WU, Taoyuan City (TW)

(21) Appl. No.: 19/122,925

(22) PCT Filed: Oct. 26, 2023
(86) PCT No.: PCT/US2023/036001

§ 371 Date: Apr. 21, 2025

Related U.S. Application Data
(60) Provisional application No. 63/382,291, filed on Nov. 3, 2022.

(51) Int. Cl. H04W 64/00; H04W 24/10; H04W 36/00; H04W 76/20; H04W 84/06

(52) U.S. Cl. CPC H04W 64/00; H04W 24/10; H04W 36/0058; H04W 76/20; H04W 84/06

(57) ABSTRACT

Methods and devices in a wireless network spanning a terrestrial network, TN, area and a non-terrestrial network, NTN, cell, provide a hand-over mechanism from the NTN cell to a TN cell of the TN area, for a user equipment, UE, camped on the NTN cell. The UE determines, while being camped on the NTN cell, whether it is within or close to the TN area and only then the UE measures a parameter a TN cell associated with the TN area.

This document relates generally to wireless communications and, more particularly, to supporting a user equipment (UE) that is connected to a non-terrestrial network (NTN) to perform inter-frequency measurement on terrestrial network (TN) frequencies.

### BACKGROUND

This background description is provided for the purpose of generally presenting the context of the embodiments described in the Detailed Description. Work of the presently named inventors, to the extent it is described in this background section, as well as aspects of the description that may not otherwise qualify as prior art at the time of filing, are neither expressly nor impliedly admitted as prior art against this document.

The objectives behind developing the fifth generation (5G) technology include providing a unified framework for such types of communication as enhanced mobile broadband (eMBB), ultra-reliable low-latency communications (URLLC), and massive machine type communication (mMTC).

The 5G technology relies primarily on legacy TNs (i.e., wireless networks described in technical specifications). However, the 3rd Generation Partnership Project (3GPP) organization has proposed to extend 5G communications to NTNs with 5G new radio (NR) technologies, or with the Long-Term-Evolution (LTE) technologies tailored for the Narrowband Internet-of-Thing (NB-IoT) or the enhanced Machine Type Communication (eMTC) scenarios. In an NTN, an RF transceiver is mounted on a satellite, an uncrewed aircraft system (UAS), also called drone, balloon, plane, or another suitable apparatus. For simplicity, the discussion below refers to all such apparatus as satellites. In addition to satellites, an NTN can include the satellite gateways (called “sat-gateway(s)” or “NTN gateway(s)”) that connect the NTN to a public data network, feeder links between sat-gateways and satellites, service links between satellites, and inter-satellite links (ISL) when satellites form constellations.

A satellite can belong to one of several types based on altitude, orbit, and beam footprint size. The types include Low-Earth Orbit (LEO) satellite, Medium-Earth Orbit (MEO) satellite, Geostationary Earth Orbit (GEO) satellite, UAS platform (including High Altitude Platform Station, HAPS), and High Elliptical Orbit (HEO) satellite. GEO satellites are also known as the Geosynchronous Orbit (GSO) satellites, and LEO/MEO satellites are also known as the non-GSO (NGSO) satellites.

A GSO satellite can communicate with one or several sat-gateways deployed over a satellite targeted coverage area (e.g., a region or even a continent). A non-GSO satellite, at different times, can communicate with one or several serving sat-gateways. An NTN is designed to ensure service and feeder link continuity between successive serving sat-gateways, with sufficient time duration to proceed with mobility anchoring and hand-over.

A satellite may transmit a transparent or a regenerative (with on board processing) payload, and typically generates several beams for a given service area bounded by the field of view. The footprints of the beams typically have an elliptic shape and depend on the on-board antenna configuration and the elevation angle. For a transparent payload implementation, a satellite can apply RF filtering and frequency conversion and amplification, and not change the waveform signal. For a regenerative payload implementation, a satellite can apply RF filtering, frequency conversion and amplification, demodulation and decoding, routing, and coding/modulation. The satellite transmitting payload in a regenerative manner is effectively equivalent to implementing most of the functions of a base station, e.g., a gNB.

In this and other cases, a UE connected via an NTN cell is preferably, whenever possible, handed over to a TN cell to receive better and more economical service. The network, through the NTN cell, configures the UE to regularly measure the TN frequency so that the UE is able to find and report at least one TN cell when TN cells are available. However, because an NTN cell coverage area is typically much larger than a TN cell coverage area, and the NTN cell coverage area may overlap a few TN cell coverage areas, there could be many UEs measuring TN frequencies in search of TN cells when in practice there are no TN cells close to the UEs, which results in power waste for these UEs.

### SUMMARY

Techniques described in one or more embodiments provide methods for a UE to selectively conduct inter-frequency measurements, while within an NTN cell. The UE, wirelessly connected to the network via the NTN cell, is configured to measure signals having at least one TN frequency associated with at least one TN cell only when the UE is close to or within a TN area that includes the TN cell(s). The BS sends the UE a list of the TN areas and associated frequencies for measurement. The UE performs inter-frequency measurements when, while in a connected state with the NTN cell, the UE determines its location (i.e., within or close to) relative to a TN area. Because the UE does not share its location with the network at this stage, the UE makes the above noted determination (and not the network). When the UE determines being within a particular TN area, the UE performs a measurement on the at least one frequency associated with that particular TN area. In view of a UE measurement report, the network decides whether to hand-over the UE to a UE-detected TN cell.

In one variation of this method, the UE may receive the list of TN areas and associated frequencies while in an idle state and determines whether it is within or close to a given TN area in the list, only after transitioning to a connected state.

In another method, the UE receives, from the BS, the list of the TN areas, but not their corresponding frequencies. The UE then determines, based on its own location, whether it is within or close to a TN area. When the UE determines that it is within or close to a TN area, the UE informs the BS about the TN area and the BS provides to the UE at least one frequency associated with the TN area. The UE then performs the inter-frequency measurements on the indicated at least one frequency. In one variation of this method, the UE receives the list of TN areas while in an idle state and determines whether it is within or close to a TN area only after transitioning to a connected state.

According to yet another method, the BS is configured to send a location indication regarding the TN areas, to a UE connected to an NTN cell. After the UE notifies the BS that the UE is within or close to a given TN area, the BS sends to the UE a corresponding frequency of the TN area enabling the UE to perform hand-over related measurements on the TN frequency of the TN area.

In a variation of this method, the BS sends a corresponding frequency of the TN area with the location indication regarding the TN area. In yet another variation of this method, the BS sends the location information in a radio resource control message and the frequency of the TN area in a system information message or a radio resource control message.

### BRIEF DESCRIPTION OF THE DRAWINGS

The accompanying drawings, which are incorporated in and constitute a part of the specification, illustrate one or more embodiments and, together with the description, explain these embodiments.

FIG. 1 is a block diagram of a wireless communication system including a UE, a BS of a non-terrestrial network (NTN), and a BS of a terrestrial network (TN);

FIG. 2 is a block diagram of a base station having a centralized unit (CU) and a distributed unit (DU);

FIG. 3 is a block diagram of an NTN node with transparent payload implementation;

FIG. 4 is a block diagram of an NTN node with transparent payload implementation, in which a base station connects to multiple satellites via the same sat-gateway;

FIG. 5 illustrates a scenario in which a UE, in a connected state, is configured to refrain from measuring TN frequencies/cells, while the UE is in an NTN cell but far away from a TN area that includes one or more TN cells.

FIG. 6 illustrates a scenario in which the UE, in the connected state, is configured to measure TN frequencies/cells, while the UE is in the NTN cell and close to or within the TN area.

FIG. 7 is a messaging diagram of a scenario showing how a UE in connected mode via an NTN cell conducts the measurement on a TN carrier frequency, where the UE might or might not be close to any TN cell operating on that TN carrier frequency.

FIG. 8 is a messaging diagram of a scenario showing how a UE in connected mode via an NTN cell transmits a proximity indication to the network and conducts the measurement on a TN carrier frequency.

FIG. 9 is a messaging diagram of a scenario showing how an idle UE receives area information in a system information broadcast and then enters a connected mode via an NTN cell and transmits a proximity indication to the network based on the area information.

FIG. 10 is a messaging diagram of a scenario showing how an idle UE receives area information in a system information broadcast and then enters a connected mode via an NTN cell and conducts a measurement on a TN carrier frequency based on the area information.

FIG. 11 is a flow diagram of a method performed by a UE in connected mode, via an NTN cell, for determining whether to conduct the measurement on a TN carrier frequency.

FIG. 12 is a flow diagram of a method performed by a UE in connected mode, via an NTN cell, for transmitting a proximity indication to the network and conducting the measurement on a TN carrier frequency.

FIG. 13 is a flow diagram of a method performed by an idle UE communicating with an NTN cell, for transmitting a proximity indication to the network based on the area information broadcasted in the system information.

FIG. 14 is a flow diagram of a method performed by an idle UE communicating with an NTN cell, for conducting the measurement on a TN carrier frequency based on the area information broadcasted in the system information.

FIG. 15 is a flow diagram of a method performed by an NTN BS, for configuring a UE with a measurement object including a TN carrier frequency to be measured and the area(s) associated to the carrier frequency.

FIG. 16 is a flow diagram of a method performed by an NTN BS, for providing a UE with a proximity indication configuration and configuring a UE to measure a TN carrier frequency upon receiving a proximity indication from the UE.

FIG. 17 is a flow diagram of a method performed by an NTN BS, for broadcasting the TN area information and receiving the proximity indication from the UE.

FIG. 18 is a flow diagram of a method performed by an NTN BS, for broadcasting the TN carrier frequency and TN area information and configuring a UE to measure a TN carrier frequency that is broadcasted in the system information.

### DETAILED DESCRIPTION OF THE DRAWINGS

As discussed in more detail below, a UE and a communication network that includes NTN and TN cells, can use the techniques of this document for managing a hand-over procedure of the UE, from the NTN cell to the TN cell while saving power at the UE and without necessarily disclosing the location of the UE to the network.

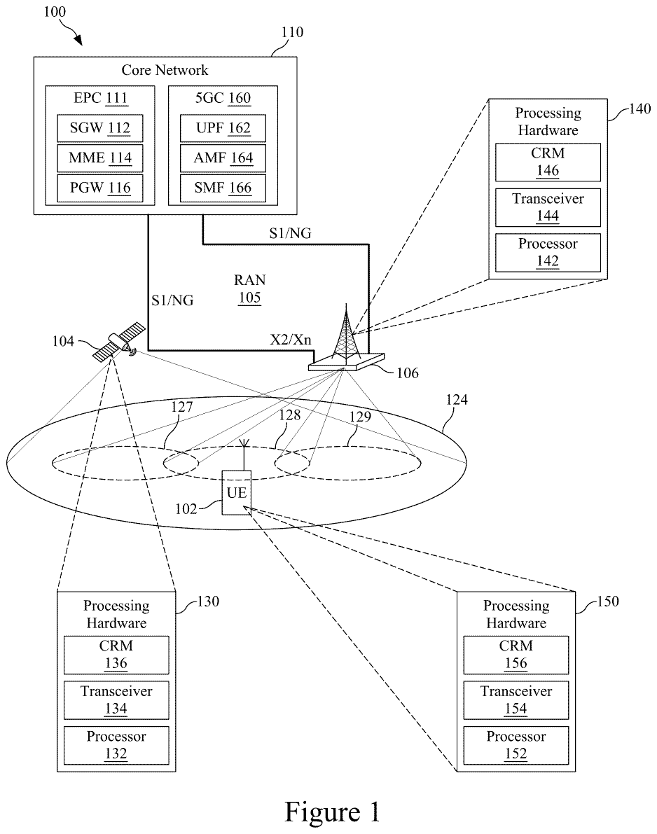

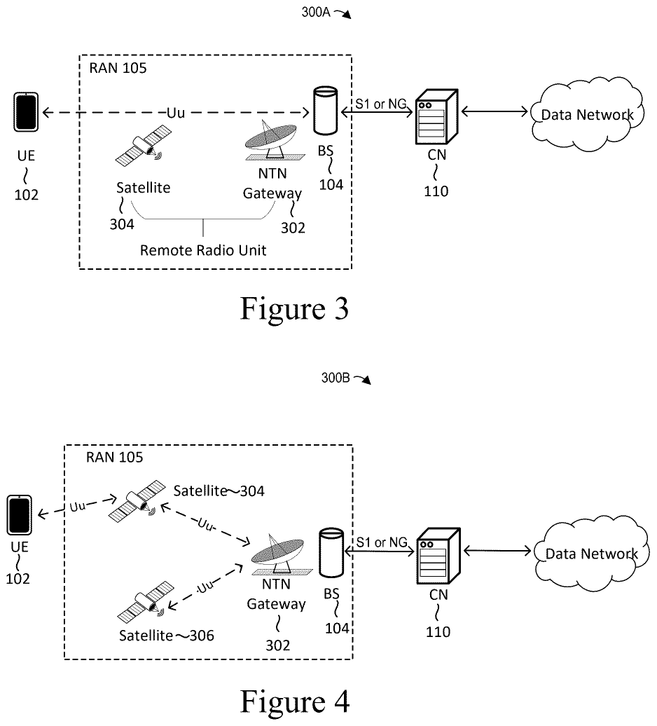

Referring to FIG. 1, a wireless communication system 100 includes a UE 102, a base station (BS) 104 that communicates with UE 102 via satellite (therefore BS 104 is represented in this figure as a satellite icon but the setup is illustrated in more detail in FIG. 3), a BS 106, and a core network (CN) 110. The BSs 104 and 106 can operate in a RAN 105 connected to the CN 110. The CN 110 may be implemented as an evolved packet core (EPC) 111 or a fifth generation (5G) core (5GC) 160 (both illustrated in FIG. 1, but it is not required both be present). The CN 110 may also include a sixth generation (6G) core (not shown).

The BS 104 may communicate with the UE 102 via a cell 124, and the BS 106 may communicate with the UE 102 via a cell 127, 128, and/or 129. If the BS 104 is a gNB, the cell 124 is an NR cell. If the BS 104 is an ng-eNB or eNB, the cell 124 is an evolved universal terrestrial radio access (E-UTRA) cell. Similarly, if the BS 106 is a gNB, the cells 127 to 129 are NR cells, and if the BS 106 is an ng-eNB or eNB, cells 127 to 129 are E-UTRA cells. Cells 124, 127, 128 and 129 may be in the same Radio Access Network Notification Areas (RNA) or different RNAs. In general, the RAN 105 may include any number of BSs, with each of the BSs able to communicate with UEs via one or more cells. The UE 102 supports at least a 5G NR (or simply, “NR”) or an E-UTRA air interface to communicate with the BSs 104 and 106. Each of the BSs 104, 106 may connect to the CN 110 via an interface (e.g., S1 or NG interface). The BSs 104 and 106 also may be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 is configured to transfer user-plane packets related to audio calls, video calls, Internet traffic, etc., and the MME 114 is configured to manage authentication, registration, paging, and other related functions. PGW 116 provides to UEs connectivity to one or more external packet data networks, e.g., an Internet network and/or an Internet Protocol (IP) Multimedia Subsystem (IMS) network.

The 5GC 160 includes a User Plane Function (UPF) 162, an Access and Mobility Management Function (AMF) 164, and/or Session Management Function (SMF) 166. The UPF 162 is configured to transfer user-plane packets related to audio calls, video calls, Internet traffic, etc., the AMF 164 is configured to manage authentication, registration, paging, and other related functions, and the SMF 166 is configured to manage packet data unit (PDU) sessions.

As illustrated in FIG. 1, TN cells 127 and 128 as well as TN cells 128 and 129 partially overlap, so that the UE 102 may select, reselect, or hand over from one of the cells to the other. FIG. 1 further shows that the TN cells overlap with the NTN cell 124, so that selection, reselection or hand over from NTN to TN is also possible. To directly exchange messages or information, the BS 104 and BS 106 may support an X2 or Xn interface. In general, the CN 110 may connect to any suitable number of BSs supporting new radio (NR) cells and/or E-UTRA cells. E-UTRA is usually associated with 3GPP Long Term Evolution (LTE) radio access technology (RAT) and NR is usually associated with 5G RAT.

The UE 102 and/or the BSs 104 and 106 may utilize the techniques described in this section when the UE 102 operates in an inactive or idle state of the protocol for controlling radio resources (i.e., Radio Resource Protocol, RRC) between the UE 102 and the core network 110 (i.e., the RRC_INACTIVE or RRC_IDLE state of the RRC protocol), but also in a connected state, as discussed later.

The BS 104 is equipped with processing hardware 130 that includes a processor 132 (but may include more than one general-purpose processor, e.g., CPUs), a transceiver 134 and a non-transitory computer-readable medium (CRM) 136, such as a memory. Additionally, or alternatively, the processing hardware 130 may include special-purpose processing units. The processor 132 is configured to process data that the BS 104 transmits in the downlink direction to the UE 102, and/or to process data that the BS 104 receives in the uplink direction from the UE 102. Transceiver 134 may include a transmitter configured to transmit data in the downlink direction, and a receiver configured to receive data in the uplink direction. CRM 136 stores executable instructions that the processor 132 executes for performing various techniques described in this section. The BS 106 includes similar components as the BS 104. In other words, the components 140, 142, 144, and 146 of the BS 106 are similar to the components 130, 132, 134, and 136 of the BS 104, respectively.

The UE 102 is equipped with processing hardware 150 that includes at least one processor 152 (but it may include more than one general-purpose processor, such as CPUs, and/or special-purpose processing units), a transceiver 154 and a non-transitory computer-readable medium (CRM) 156, such as a memory. Processor 152 is configured to process data that the UE 102 transmits in the uplink direction, and/or to process data received by UE 102 in the downlink direction. Transceiver 154 may include a transmitter configured to transmit data in the uplink direction, and a receiver configured to receive data in the downlink direction. CRM 156 stores executable instructions that processor 152 executes for performing various techniques described in this section.

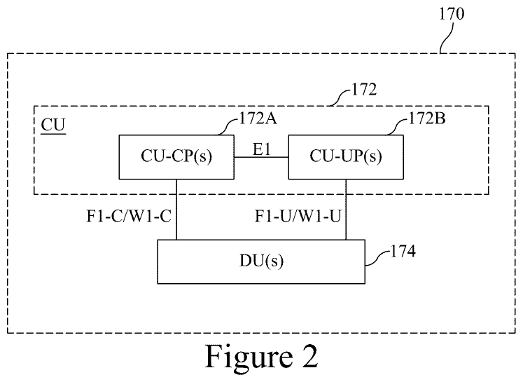

FIG. 2 is a block diagram of a distributed BS 170 that may operate as BS 104 or 106 in the system illustrated in FIG. 1. BS 170 includes a central unit (CU) 172 and at least one distributed unit (DU) 174. Each CU and DU includes processing hardware, such as one or more general-purpose processors (e.g., CPUs) and/or special-purpose processing units, a transceiver and a CRM storing machine-readable instructions executable on by the processor(s). A DU or a CU may operate as BS 104 or 106 in the system illustrated in FIG. 1. The CU may operate as a packet data convergence protocol (PDCP) controller, an RRC controller and/or an RRC inactive controller. The CU may also operate as a radio link control (RLC) controller configured to manage or control one or more RLC operations or procedures. The DU may operate as a media access control (MAC) controller configured to manage or control one or more MAC operations or procedures (e.g., a random-access procedure), an RLC controller configured to manage or control one or more RLC operations or procedures, and/or a physical layer controller configured to manage or control one or more physical layer operations or procedures.

In some embodiments, RAN 105 supports Integrated Access and Backhaul (IAB) functionality. In some implementations, the DU 174 operates as an IAB-node, and the CU 172 operates as an IAB-donor. In some embodiments, RAN 105 supports NTN functionality.

The CU 172 may include a logical node CU-CP 172A that hosts the control plane part of the PDCP protocol of the CU 172. The CU 172 may also include logical node(s) CU-UP 172B that hosts the user plane part of the PDCP protocol and/or Service Data Adaptation Protocol (SDAP) protocol of the CU 172. The CU-CP 172A may transmit control information (e.g., RRC messages, F1 application protocol messages), and the CU-UP 172B may transmit the data packets (e.g., SDAP PDUs or Internet Protocol packets). The CU-CP 172A may be connected to multiple CU-UP (such as CU-UP 172B) through the E1 interface. CU-CP 172A selects the appropriate CU-UP 172B for the requested services for UE 102. In some implementations, a single CU-UP (such as CU-UP 172B) may connect to multiple CU-CP (such as CU-CP 172A) through the E1 interface. The CU-CP 172A may connect to one or more DUs (such as DU 174) through an F1-C interface. The CU-UP 172B may connect to one or more DUs (such as DU 174) through the F1-U interface under the control of the same CU-CP 172A. In some implementations, one DU (such as DU 174) may connect to multiple CU-UP 172B under the control of the same CU-CP 172A. In such implementations, the connectivity between a CU-UP and a DU is established by the CU-CP using Bearer Context Management functions.

FIG. 3 is a schematic illustration of an NTN network operating with a transparent payload architecture. A satellite (NTN) gateway 302 and a “transparent” satellite 304 extend the range of BS 104's Uu interface. The satellite 304 may use a frequency conversion and a Radio Frequency (RF) amplifier in both the uplink and downlink directions. The satellite function is similar to that of an analogue RF repeater. As a result, the satellite 304 repeats the Uu radio interface signals transmitted via the feeder link (between the NTN gateway and the satellite) and then the service link (between the satellite and the UE) in the downlink direction and vice versa in the uplink direction. The Satellite Radio Interface (SRI) of the feeder link is the Uu, and the NTN gateway 302 supports all necessary functions to forward the signal of the Uu interface. The NTN gateway 302 may be collocated with the BS (e.g., eNB, gNB) 104, or may be connected to the BS 104 via a wired link. It is also possible to have more than one NTN gateway connected to a BS. Different transparent satellites such as 304 may be connected to the same terrestrial BS via the same NTN gateway, or via different NTN gateways. FIG. 4 illustrates the case where two different satellites (304 and 306) are connected to the same BS 104 via the same NTN gateway 302. These two satellites (304 and 306) emit beams to the Earth surface for two NTN cells with two different Physical Cell IDs (PCIs).

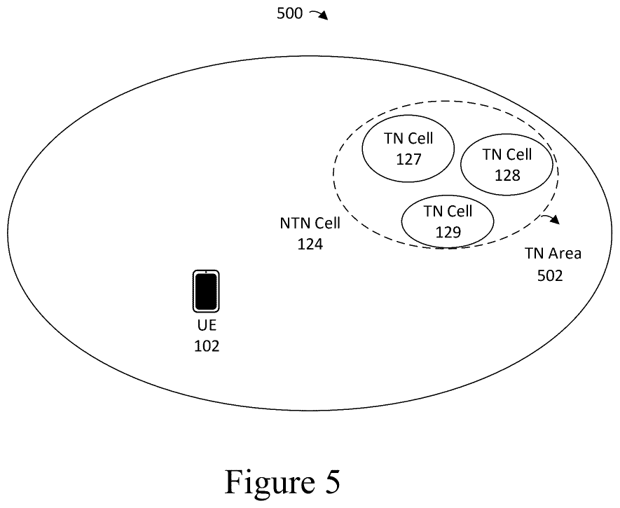

FIG. 5 is an example scenario showing how the network (i.e., the BS 104 or a network entity of the BS 104, or any other part of the network discussed above) configures a UE 102 to measure the TN frequencies/cells, when the UE is in a connected state and is connected to the NTN cell 124. Note that the UE is in a “connected state” when the UE is actively communicating with the BS serving the NTN cell 124. The UE is in an “idle state” when not actively communicating with the BS. The idle state is often associated with periods when the UE is not using data services, making calls, or sending/receiving messages. In this scenario, UE 102 is within the coverage of the NTN cell 124 and connected to it. In addition, the NTN cell 124 includes three TN cells (TN Cell 127, TN Cell 128, and TN cell 129) that are close to each other and have a much smaller footprint size than the NTN cell. In one application, these TN cells are operating in the same frequency band, which may be different from that of the NTN cell 124. In this scenario, the network would prefer UEs to connect to the TN cells if the UEs are within the coverage of the TN cells, as a TN cell typically provides better throughput than the NTN cell does. Therefore, the network may configure UE 102 to conduct the measurement on the frequency operated by these TN cells for performing a handover if at least one TN cell is available.

To configure the UE 102 for conducting the measurement on the frequency operated by at least one TN cell, the network entity (e.g., the BS 104) may configure a measurement object (e.g., measObjectNR defined in 3GPP technical specifications) indicating a TN frequency to be measured (e.g., ssbFrequency defined in 3GPP technical specifications) and send the measurement object to the UE 102, via an RRCReconfiguration message (as defined in 3GPP technical specifications). Note that in the rest of this document, terms defined in 3GPP technical specifications are written using italics or capital letters without further describing their source, and they are illustrative not limiting. In one embodiment, the network also includes the physical cell identities of the TN cells 127, 128, and 129 in the allowed cell list in the measurement object. The network may also provide the UE 102 with a measurement gap configuration that aligns the NTN inactive periods with the synchronization signal and PBCH block (SSB) transmission timing of the TN frequency, so that the UE 102 is able to regularly switch from the serving frequency (of the NTN cell) to the TN frequency (of the TN cell(s)) to conduct the inter-frequency measurement.

Conventionally, after UE 102 is configured with the measurement object indicating the TN frequency to be measured, the UE 102 has to constantly conduct the measurement on the indicated TN frequency when the service cell measurement is below a certain threshold, no matter where the UE 102 is currently located, i.e., far away from any TN cell (as shown in FIG. 5) or close to such a cell. As a result, the UE 102 may not be able to detect any TN cell for most of the time while conducting measurement on the TN frequency. Eventually, if the UE is not close to any TN cell, the UE ends up wasting power with no effective result (i.e., not finding an appropriate TN cell to connect to).

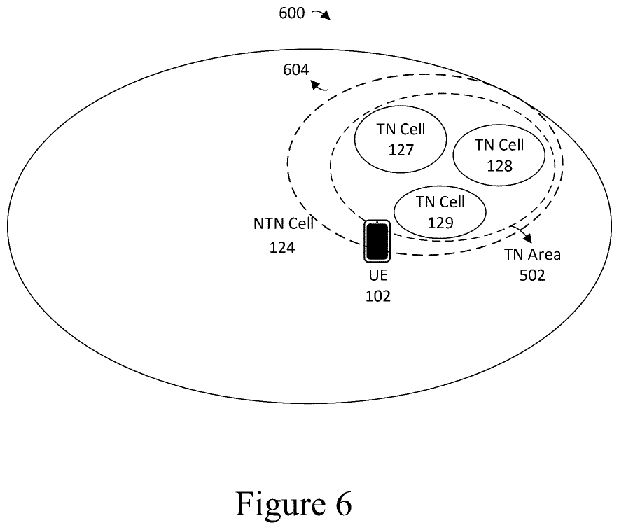

According to an embodiment, a “TN area” 502 (see FIG. 5) is defined to avoid this problem. TN area is associated with the combined area of one or more TN cells, which may share the same TN frequency. Using this concept, the UE is configured to perform measurements on the TN frequency only when close or within the TN area, thus saving energy when not within or close to the TN area. The TN area in this embodiment may be characterized by a central physical location and a distance parameter, e.g., a radius. Additional parameters that may be used for the TN area will be discussed later. As shown in FIG. 6, if the UE 102 is close to the TN area 502 or is within the TN area 502, the UE 102 is likely able to detect at least one TN cell within the TN area via measurement and hence, is able to trigger the NTN-to-TN hand-over after sending a corresponding measurement report to the network. Therefore, it would be advantageous if a technique configures the UE 102 to conduct the measurement on the TN frequency only if the UE 102 is in the vicinity of the TN area or is within the TN area that includes the TN cells. Alternatively, it would also be advantageous if a technique configures the UE 102 to determine if the UE 102 is in the vicinity of the TN area or is within the TN area that includes the TN cells and only then to measure the TN frequency. As long as the UE starts conducting the measurement and is able to detect any TN cell in the TN area, cell measurement may be triggered and reporting this measurement to the BS may lead to the subsequent hand-over procedure.

The TN area may be defined as being the area enclosed by a perimeter, e.g., a circle, an ellipse, or a polygon (with n sides, where n is an integer equal to or larger than 3). Those skilled in the art would understand that the perimeter of the TN area may also be defined using one or more functions, i.e., using parametrization.

Depending on the shape of the perimeter of the TN area, two or more parameters may be needed for locating in space the TN area (i.e., its boundary). For example, if the TN area's perimeter is a circle, a central location (e.g., x, y, and z coordinates) and a radius (the distance parameter) of the circle may be needed to fully define and localize the TN area. If the TN area's perimeter is a rectangle or ellipse, a central location and two distances (two distance parameters, e.g., distances from the central location to the small and large sides of the rectangle or the semi-minor and semi-major axes of the ellipse) may be needed to fully define and localize the TN area. In other words, the number of parameters that fully define the TN area depends on the shape of the perimeter of the TN area.

A TN area may include any number of TN cells. While the TN area may also include only one TN cell, for this specific case, the TN area does not achieve its full potential. If two or more TN cells are present in the TN area, then the network reduces the overhead signaling between the BS and the UE as the BS may provide a single TN frequency for the entire TN area, and thus, the UE performs a measurement on the single TN frequency for detecting/evaluating any of the TN cells in the TN area, instead of performing multiple measurements on multiple frequencies. In one embodiment, the physical area of the TN area is larger than the combined physical areas of the TN cells located within the TN area.

The embodiments discussed herein equally apply when the UE is within the TN area or when the UE is “close” to the TN area. In this regard, the coverage area of a TN cell (in 3G, 4G, LTE or 5G) is defined by the geographic area that a particular cell or base station can serve with reliable and high-quality wireless communication. However, if the UE is not within the coverage area of any TN cell in the TN area, the UE might still communicate with a TN cell in the TN area, but with a medium- or low-quality wireless connection. This means that there is an envelope 604 of the TN area 502, as schematically illustrated in FIG. 6, which may support communication between the UE 102 and one of the TN cells of the TN area 502, even if not with high-quality. The envelope 604 may fully enclose the TN area 502.

Thus, in the following embodiments, the UE 102 is “close” to the TN area 502 when the UE is within the envelope 604. In one application, the shape of the envelope 604 mimics the shape of the corresponding TN area 502. An area of the envelope is always larger than an area of the corresponding TN area. In one application, the area of the envelope is at least 5% larger than the area of the corresponding TN area. The percentage may be larger or smaller, as appropriate for the TN cells of the TN area. Although only one TN area is shown for the sake of simplicity, an NTN cell coverage area may encompass multiple non-overlapping or overlapping TN areas.

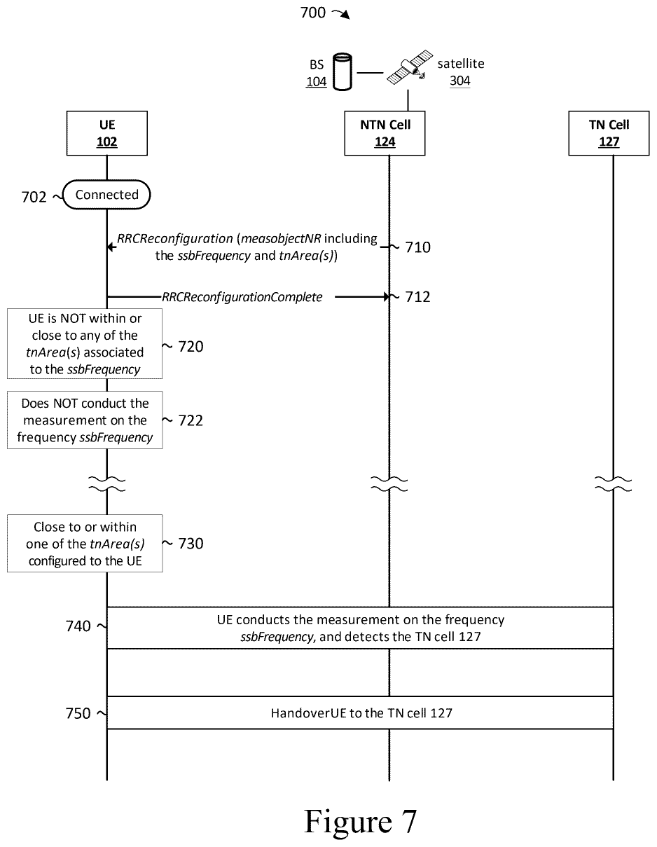

Next, several scenarios in which a UE and/or a RAN and/or a BS implement one or more of the above techniques for avoiding wasting power for TN measurements are discussed with reference to FIGS. 7 to 10. The term “network” is used in this document to refer to the RAN or BS or any part of RAN or BS. These techniques are advantageously supporting NTN-to-TN mobility when the UE is in connected state, resulting in enhanced UE power saving. These techniques also support NTN-to-TN mobility when the UE is in an idle state and transition to a connected state for determining when the UE is close to a TN area or is within the TN area. Similar events in FIGS. 7 to 10 are labeled with similar reference numbers, with differences discussed below where appropriate. For example, event 710 is similar to event 810 and event 1010, and event 730 is similar to event 830, event 930, and event 1030. To simplify the following description, the term “inactive state” is used and can represent the RRC_INACTIVE or RRC_IDLE state, and the term “connected state” is used and can represent the RRC_CONNECTED state.

FIG. 7 is a messaging diagram 700 of a scenario showing how a connected UE (i.e., in a connected state) selectively conducts the measurement on a TN carrier frequency of a TN cell in a TN area, where the UE may or may not be close to any TN cell operating in that carrier frequency. In FIG. 7, UE 102 initially connects to the BS 104 associated with the NTN Cell 124, via satellite 304, where the NTN cell 124 covers another TN cell 127, which is part of TN area 502. While remaining in connected state with the NTN cell 124, UE 102 receives 710, an RRCReconfiguration message (generically referred to as “TN information message”) including a measurement object configuration indicating a TN carrier frequency used by TN area 502 (and implicitly used by at least one TN cell; in this embodiment, the TN cell 127) and the TN area(s) associated to the carrier frequency. Note that the UE may receive one or more TN areas in step 710 and associated frequency.

Information about each TN area can be provided in the format {reference location, radius} if the TN area is circular, where the reference location represents a central location of the TN area and the radius represents the radius of the TN area. If the TN area is not circular, as discussed above, other geometrical features (e.g., angles, sides) may be provided for describing the location of the TN area and its extent in space. In one embodiment, the information about the TN area may also include information about its envelope 604. For example, the envelope may be defined by a given range. If the TN area is circular, the UE is close to the TN area when a distance between the reference point of the TN area and a location of the UE is within the given range, which has a lower bound equal to the radius of the TN area and a higher bound equal to the radius plus a given distance.

In response to the RRCReconfiguration message, the UE 102 applies the configurations and then transmits 712 an RRCReconfigurationComplete message to the NTN cell 124. Next, the UE 102 determines 720 that it is not within or close to any of the TN areas associated to the TN carrier frequency received in step 710. If this is the case, the UE decides 722 not to conduct the measurement on the TN carrier frequency, thus saving power. In one implementation, the UE 102 determines whether it is within the TN area or not, by reading its GNSS coordinate from the GNSS module and examining whether the GNSS coordinate falls within the bounds of the TN area. In this or another implementation, the UE 102 determines whether it is close to the TN area (i.e., outside the TN area but close enough to be able to communicate with a TN cell from within the TN area), by reading its GNSS coordinate from the GNSS module and examining whether the GNSS coordinate falls within the envelope of the TN area (which may have a radius larger than the radius of the TN area). To facilitate UE to determine whether it is close to the TN area or not, the location and/or size of the envelope can be provided by the network to the UE via system information or via dedicated RRC messages, which is then used by the UE to examine whether the distance between the reference location of the TN area and UE's GNSS coordinate has exceeded the size of the envelop (if the UE is outside the envelope, the UE is not close to the TN area; otherwise UE is close to the TN area).

Later, the UE 102 determines 730 that it has moved into one of the TN areas associated with the received TN carrier frequency. In response to this determination, UE 102 conducts 740 the inter-frequency measurement on the associated TN carrier frequency, and then detects, for example, the TN cell 127 in the TN area 502, upon performing the measurement. Note that the UE can detect any TN cell within the TN area. UE 102 reports this measurement to the network, which may in turn trigger the hand-over procedure that makes the network hand-over 750 UE 102 from the NTN Cell 124 to the found TN cell 127.

In one embodiment, the UE receives 710 a RRCReconfiguration message including plural measobjectNR information elements, IE, where at least two IEs indicate or describe a same TN area. Because each measobjectNR supports one TN frequency, in this embodiment, the UE may receive plural TN areas with at least one TN area having different TN frequencies. For this case, the UE performs steps 720, 722 and 730 for each TN frequency of the at least one TN area. This procedure may also be implemented in the embodiments next discussed.

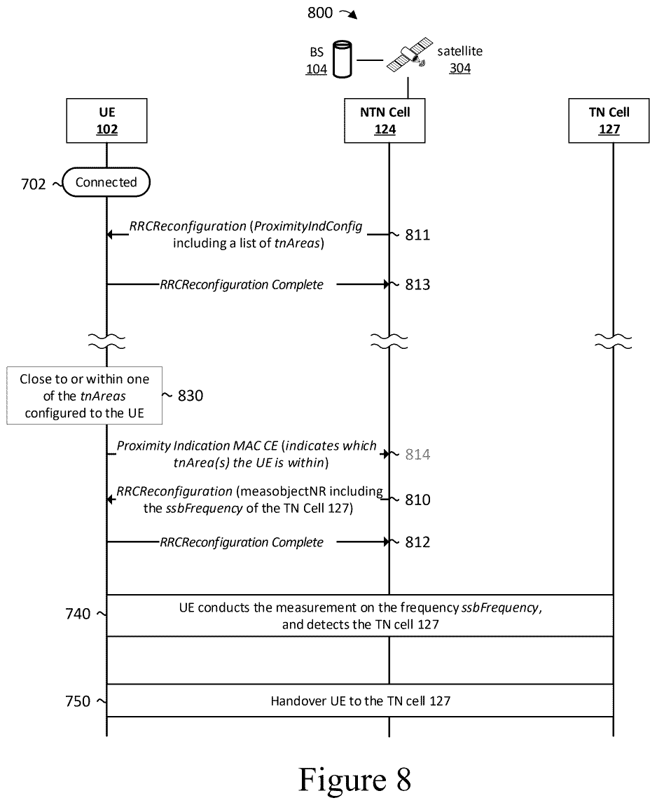

FIG. 8 is a messaging diagram 800 of another scenario showing how a connected UE transmits a proximity indication to the network and conducts the measurement on a TN carrier frequency while connected to the NTN cell. The message diagram in FIG. 8 is similar to that in FIG. 7, with the differences discussed below. In FIG. 8, after connecting to the BS 104 of the NTN cell 124 via the satellite 304, the UE 102 receives 811, via the NTN Cell 124, an RRCReconfiguration message including a proximity indication configuration (i.e., ProximityIndConfig), which includes a list of TN areas that overlap with the NTN cell 124. The proximity indication configuration may include location information about each TN area, e.g., a reference location and a radius if the TN area is circular. Note that in this embodiment, the message in step 811 does not include a frequency associated with the TN areas. Thus, at this stage, the UE cannot conduct any measurement of a TN cell associated with a TN area even if the UE is within or close to the TN area. In response to the RRCReconfiguration message, the UE 102 applies the proximity indication configuration, stores the list of TN areas, and transmits 813 an RRCReconfigurationComplete message to the NTN Cell 124.

Later, the UE 102 determines 830 that it is close to or has moved within one of the TN areas stored by the UE in the proximity indication configuration, and that TN area is the area where the TN cell 127 is located. UE 102 determines whether it is within or close to the TN area 502 or not as discussed above with regard to FIG. 7. In response to the location determination in step 830, the UE 102 transmits 814 a proximity indication message to the BS 104 to indicate it is within or close to the TN area 502, where the proximity indication message can be a specific UL MAC CE, in which each bit sequentially represents each TN area stored by the UE (i.e., 1^{st} bit in the MAC CE represents the first TN area signaled in the RRCReconfiguration message, 2^{nd} bit in the MAC CE represents the second TN area signaled in the RRCReconfiguration message, . . . , etc.). Each bit in the proximity indication MAC CE can be either ‘0’ or ‘1’, where ‘0’ indicates the UE is not within or close to the represented TN area and ‘1’ indicates the UE is within or close to the represented TN area.

After receiving the proximity indication message from the UE 102, the BS 104 determines that the UE 102 is close to the TN area 502 and hence transmits 810 to the UE 102 an RRCReconfiguration message including a measurement object configuration indicating a TN carrier frequency used by TN cells in the TN area 502. In response to the RRCReconfiguration message, UE 102 conducts 740 the inter-frequency measurement on the indicated TN carrier frequency, and then detects the TN cell 127 (where cell 127 is selected as an example, and in fact that UE may measure any cell within the TN area) upon performing the measurement. The UE 102 may send the measurement report to the network, which may in turn trigger the hand-over procedure that makes the network hand-over 750 the UE 102 from the NTN cell 124 to the TN cell 127 (or other cell from within the TN area 502).

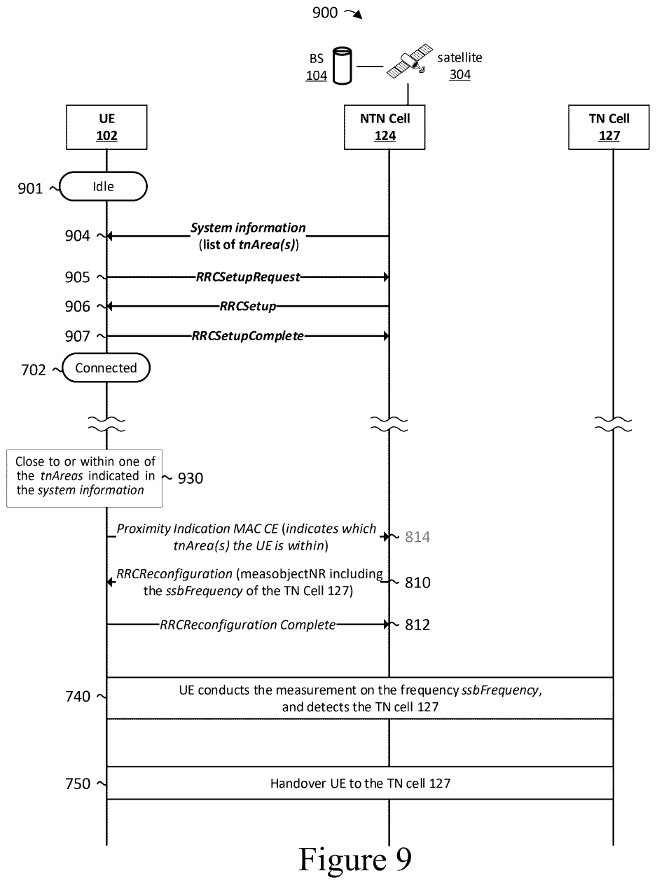

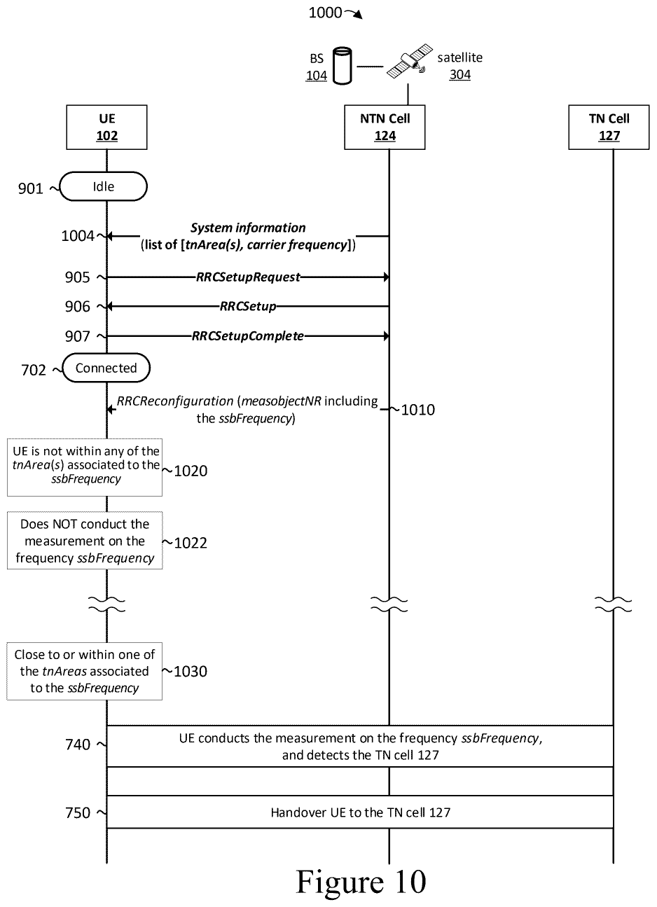

While the embodiments discussed above with regard to FIGS. 7 and 8 considered UE 102 being in a connected state, the embodiments discussed next, with regard to FIGS. 9 and 10, consider that the UE is initially in an idle state and then the UE 102 transitions to a connected state. More specifically, FIG. 9 is a messaging diagram 900 of a scenario showing that an idle UE becomes a connected UE and then transmits a proximity indication to the network based on the area information broadcasted in the system information. The message diagram in FIG. 9 is similar to that in FIG. 8, with the differences discussed below. In FIG. 9, UE 102 initially stays 901 in the idle state and acquires 904 the system information including a list of TN areas (i.e., tnArea) from the NTN Cell 124, where each TN area can be provided with the format {reference location, radius}. As previously discussed, if the shape of the TN area is not circular, the radius can be replaced by one or more distance parameters that describe the extent of the area of the TN area. Note that in step 904, the UE does not acquire the TN frequency associated with the TN area. The UE 102 then stores the list of TN areas internally as the proximity indication configuration. After that, the UE 102 performs the RRC connection setup procedure with the BS 104 and then transitions 702 to the connected state, where the RRC connection setup procedure involves the UE 102 sending 905 the RRCSetupRequest message to BS 104, BS 104 sending 906 the RRCSetup message to UE 102, and UE 102 sending 907 the RRCSetupComplete message to BS 104. In one application, if the UE 102 is able to receive the system information and communicate with the BS 104 in the connected state at the same time, step 904 can be performed by the UE 102 after the UE has entered the connected state. In this case, the UE 102 stores the list of TN areas after the UE has established the RRC connection with the BS 104.

After connecting to the BS 104, the UE 102 may move closer to the TN area 502 and hence determine 930 that it is close to or has moved within one of the TN areas stored by the UE in the proximity indication configuration. In response to this determination, the UE 102 transmits 814 a proximity indication message to the BS 104 to indicate it is within or close to the TN area 502. Moving forward, the rest of the procedure is the same as that in FIG. 8 and for this reason the same reference numbers are used for the similar steps.

FIG. 10 is a messaging diagram 1000 of a scenario showing that an idle UE changes to a connected UE and then conducts the measurement on a TN carrier frequency, of the TN area information broadcasted in the system information received by the UE while in the idle state. The message diagram in FIG. 10 is similar to that in FIG. 9, with the differences discussed below. In FIG. 10, the UE 102 initially stays 901 in the idle state and acquires 1004 the system information, which includes a list of at least one TN area associated with a corresponding TN carrier frequency. For example, the list may include a TN frequency 1 and associated TN area 1, TN frequency 2 and associated TN areas 2 and 3, and TN frequency 3 and associated TN area 1. While this example list includes only three members, the list may have more or less members. Step 1004 is performed via the NTN Cell 124. UE 102 then stores the list of carrier frequencies and the TN areas associated to each of the carrier frequencies internally. After that, the UE 102 performs the RRC connection setup procedure (905, 906, and 907) with the BS 104 and then transitions 702 to the connected state. In one application, if the UE 102 is able to receive the system information and communicate with the BS 104 in the connected state at the same time, step 1004 can be performed by the UE 102 after the UE has entered the connected state. In this case, the UE 102 stores the list of TN frequencies (and the associated TN areas) after the UE has established the RRC connection with the BS 104.

Upon transitioning into the connected state, the UE 102 receives 1010 an RRCReconfiguration message including a measurement object configuration indicating a TN carrier frequency (i.e., ssbFrequency). This TN carrier frequency may be used by the TN area 502, for example, the TN cell 127. After that, as UE 102 determines 1020 that it is not within or close to any of the TN areas associated to that TN carrier frequency, UE 102 further determines 1022 not to conduct the measurement on the TN carrier frequency.

UE 102 then may move closer to the TN area 502 and hence, determines 1030 that it is close to or has moved into one of the TN areas associated with the TN carrier frequency. In response to this determination, the UE 102 conducts 740 the inter-frequency measurement on the TN carrier frequency, and then detects the TN cell 127 (or any other cell from the TN area) upon performing the measurement. UE 102 may send the measurement report to the network, which may in turn trigger the hand-over procedure that makes the network hand-over 750 the UE 102 from the NTN cell 124 to the TN cell 127.

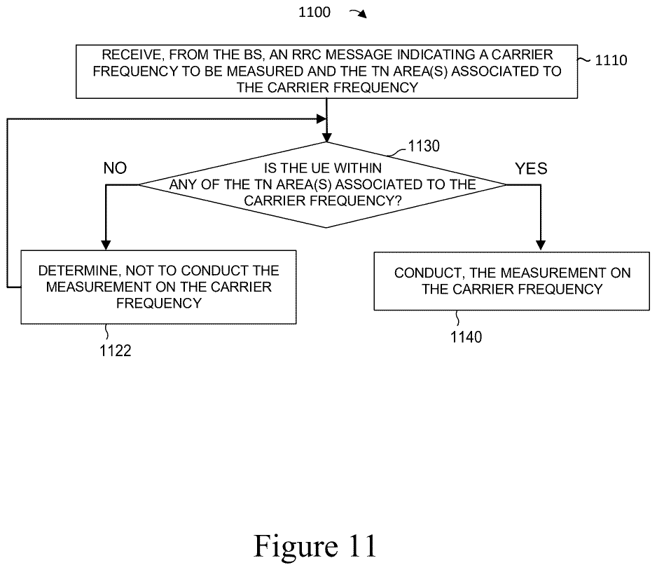

FIG. 11 is a flow diagram of a method 1100 performed by a UE (e.g., UE 102 in this disclosure), for determining whether to conduct the measurement on a TN carrier frequency while connected to an NTN cell. This method corresponds to the scenario shown in FIG. 7. Initially, the UE receives 1110, from the BS, an RRC message indicating a carrier frequency to be measured and the TN area(s) associated with the carrier frequency. In one application, the UE may receive one carrier frequency for each TN area if multiple TN areas are provided. In this or another embodiment, it is possible to provide multiple TN frequencies for a given TN area. If multiple TN frequencies are provided for the given TN area, the UE is configured to perform the step 720 or 1020 one time for each TN frequency, even if these TN frequencies are associated to the same TN area. UE determines 1130 whether the UE is within or close to any of the TN area(s) associated with the carrier frequency.

If the determination at 1130 is ‘YES’ (i.e., UE is within or close to any of the TN area(s) associated with the carrier frequency), the UE conducts 1140 the measurement on the carrier frequency. If multiple TN frequencies were provided for the given TN area, the UE is configured to perform the step 720 or 1020 one time for each TN frequency, even if these TN frequencies are associated to the same TN area.

Alternatively, if the determination at 1130 is ‘NO’ (i.e., UE is neither within nor close to any of the TN area(s)), the UE determines 1122 not to conduct the measurement on the associated carrier frequency, and then the flow returns to the decision step 1130. In this way, the UE saves power by not performing the measurement when no TN area is in range.

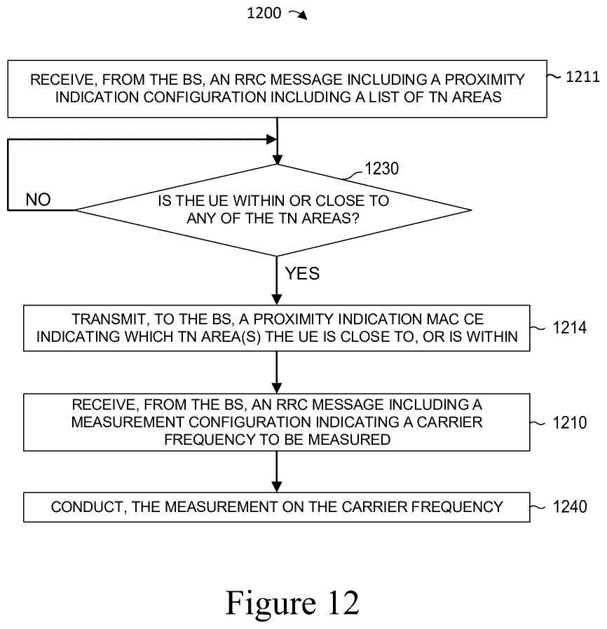

FIG. 12 is a flow diagram of a method 1200 performed by a UE (e.g., UE 102 in this disclosure), for transmitting a proximity indication to the network and conducting the measurement on a TN carrier frequency while connected to an NTN cell. This method corresponds to the scenario shown in FIG. 8. UE receives 1211, from the BS, an RRC message including a proximity indication configuration including a list of TN areas. After that, the UE determines 1230 whether the UE is within or close to any of the TN area(s) configured in the proximity indication configuration.

If the determination 1230 is ‘YES’ (i.e., UE is within or close to any of the TN area(s)), UE transmits 1214 to the BS a proximity indication MAC CE indicating which TN area(s) the UE is within or is close to. After that, the UE, receives 1210, from the BS, an RRC message including a measurement configuration indicating a carrier frequency to be measured. UE conducts 1240 the measurement on the received carrier frequency based on the measurement configuration provided in the RRC message. Alternatively, if the determination 1230 is ‘NO’ (i.e., UE is neither within nor close to any of the TN area(s)), the flow returns to the decision step 1230.

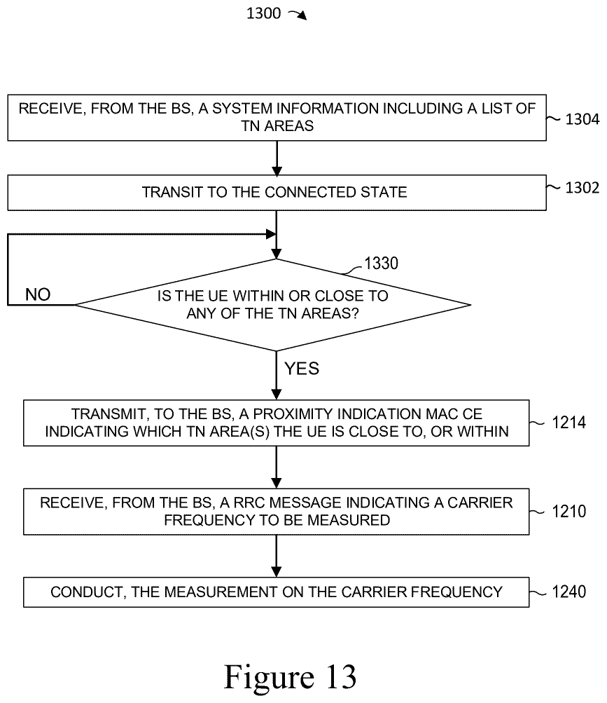

FIG. 13 is a flow diagram of a method 1300 performed by a UE (e.g., UE 102 in this disclosure), for transmitting a proximity indication to the network based on the area information broadcasted in the system information. The method corresponds to the scenario shown in FIG. 9. The flow diagram in FIG. 13 is similar to that in FIG. 12, with the differences discussed below. UE receives 1304, from the BS, a system information including a list of TN areas. After that, the UE transits 1302 to the connected state. In one application, the sequence of steps 1304 and 1302 can be reversed if the UE is able to receive the system information and communicate with the BS at the same time in the connected state. The UE determines 1330 whether the UE is within or close to any of the TN areas listed in the system information.

If the determination 1330 is ‘YES’ (i.e., UE is within or close to any of the TN area(s)), UE transmits 1214, to the BS, a proximity indication MAC CE indicating which TN area(s) the UE is close to or is within. The UE then receives 1210 a TN frequency associated with the identified TN area and conducts 1240 the measurement to detect a TN cell of the identified TN area. However, if the determination 1330 is ‘NO’ (i.e., UE is neither within nor close to any of the TN area(s)), the flow returns to the decision step 1330.

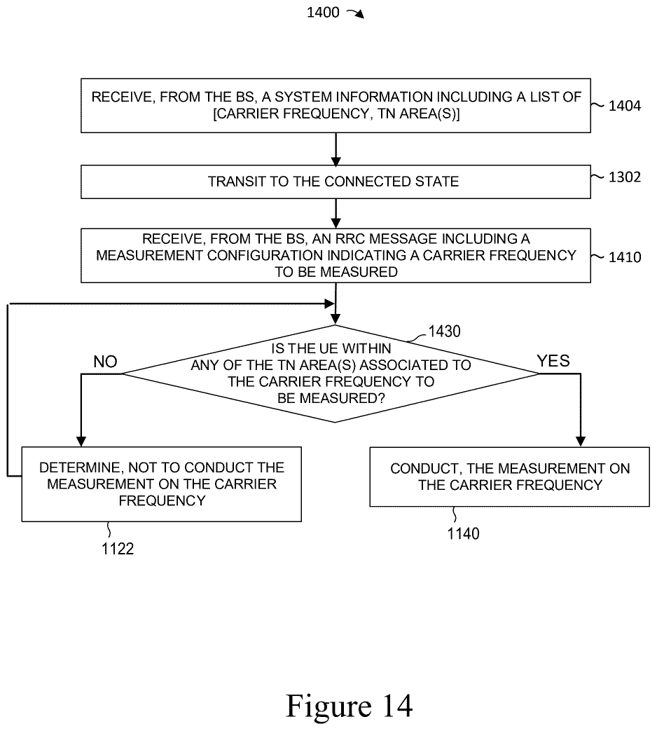

FIG. 14 is a flow diagram of a method 1400 performed by a UE (e.g., UE 102 in this disclosure), for conducting the measurement on a TN carrier frequency based on the area information broadcasted in the system information. UE receives 1404, from the BS, a system information including a list of carrier frequencies and the TN areas (one or more than one TN areas) associated to each of the carrier frequencies. UE then transits 1302 to the connected state, and then receives 1410, from the BS, an RRC message including a measurement configuration indicating a carrier frequency to be measured. In one application, the sequence of steps 1404 and 1302 can be reversed if the UE is able to receive the system information and communicate with the BS at the same time in the connected state.

The UE determines 1430 whether it is within any of the TN area(s) listed in the system information and associated to the carrier frequency to be measured. If the determination 1430 is ‘YES’ (i.e., UE is within or close to any of the TN area(s) associated to the carrier frequency to be measured), the UE conducts 1140 the measurement on the carrier frequency.

Alternatively, if the determination 1430 is ‘NO’ (i.e., UE is neither within nor close to any of the TN area(s) associated with the carrier frequency to be measured), the UE determines 1122 not to conduct the measurement on the carrier frequency, and then the flow returns to the decision step 1430.

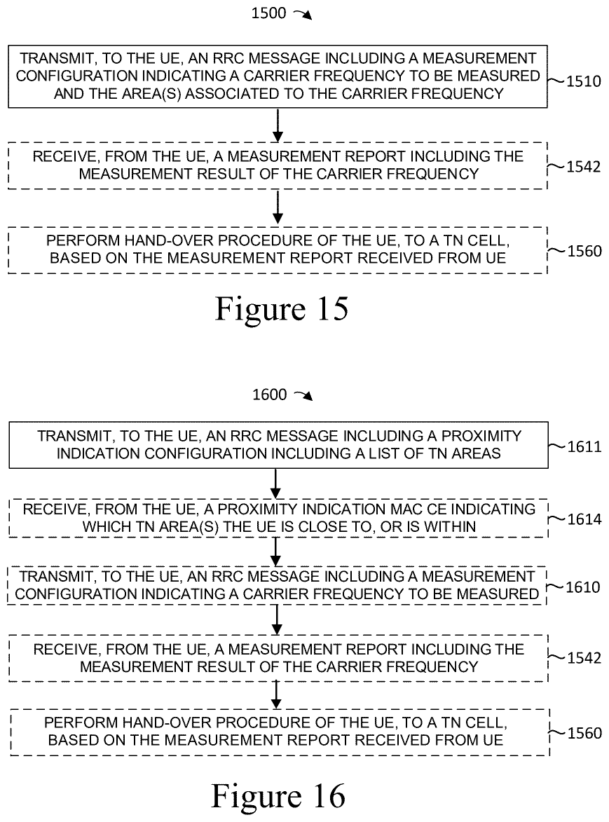

The above embodiments discussed with regard to FIGS. 11 to 14 described the scenarios illustrated in FIGS. 7 to 10 from the UE point of view. The next figures describe the same scenarios but from the NTN BS point of view. FIG. 15 is a flow diagram of a method 1500 that can be implemented by an NTN BS (e.g., BS 104 in this disclosure), for configuring a UE with a measurement object including a TN carrier frequency to be measured and the TN area(s) associated with the carrier frequency. This method corresponds to the scenario illustrated in FIG. 7. BS transmits 1510, to the UE, an RRC message including a measurement configuration indicating a carrier frequency to be measured and the TN area(s) associated with the carrier frequency. After that, the BS may receive 1542, from the UE, a measurement report including the measurement result of the carrier frequency to be measured. The measurement results may provide data about a UE proximal TN cell 127 that may support a handover. The network then optionally performs 1560 a hand-over procedure of the UE 102, to the TN cell 127, based on the measurement report received from the UE 102.

FIG. 16 is a flow diagram of a method 1600 that can be implemented by an NTN BS (e.g., BS 104 in this disclosure), for initially providing a UE with a proximity indication configuration and later configuring the UE to measure a TN carrier frequency upon receiving a proximity indication from the UE. This method corresponds to the scenario illustrated in FIG. 8. The BS transmits 1611, to the UE, an RRC message including a proximity indication configuration including a list of TN areas, but no carrier frequency for any of the TN areas. After that, the UE determines if it is close to or within a TN area, and the BS may receive 1614, from the UE, a proximity indication MAC CE indicating that TN area. Note that at this stage, the BS did not provide the UE with any TN frequency associated with the TN areas.

After receiving the proximity indication from the UE, the BS transmits 1610 to the UE, an RRC message including a measurement configuration indicating a carrier frequency to be measured, where the carrier frequency to be measured is the TN carrier frequency used by one or more than one TN cells 127 located in the TN area the UE indicates.

After transmitting the RRC message including a measurement configuration to the UE, the BS may receive 1542 from the UE, a measurement report including the measurement result of the TN cell 127. The network then optionally performs 1560 a hand-over procedure of the UE 102, to the TN cell 127, based on the measurement report received from the UE 102.

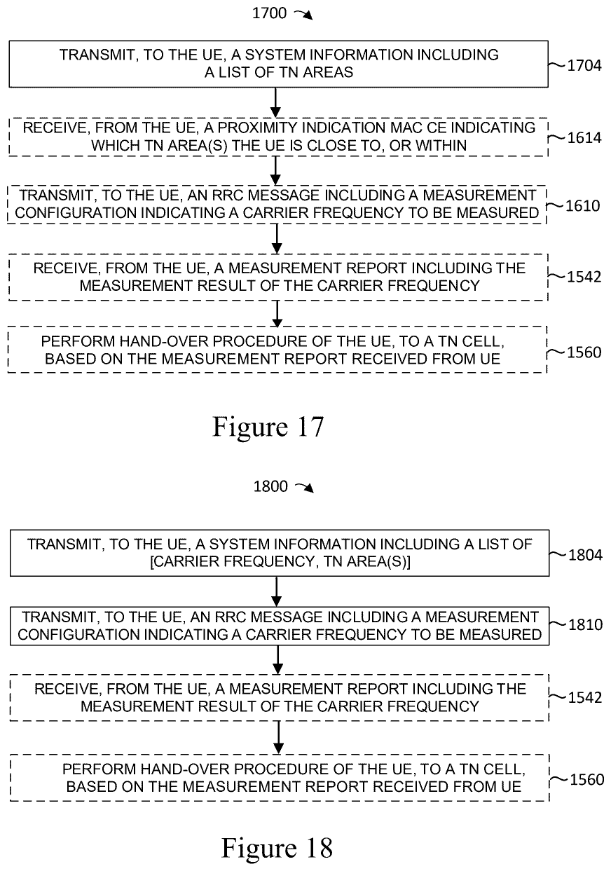

FIG. 17 is a flow diagram of a method 1700 that can be implemented by an NTN BS (e.g., BS 104 in this disclosure), for broadcasting the TN area information and receiving the proximity indication from the UE. This method corresponds to the scenario illustrated in FIG. 9. The BS transmits 1704, to the UE, a system information including a list of TN areas 502 while the UE is in an idle state in the NTN cell 124. After the UE transitions to the connected state, the BS may receive 1614, from the connected UE, a proximity indication MAC CE indicating which TN area(s) the UE is close to or is within. After receiving the proximity indication from the UE, the BS transmits 1610 to the UE, an RRC message including a measurement configuration indicating a carrier frequency to be measured, where the carrier frequency to be measured is the TN carrier frequency used by one or more than one TN cell 127 located in the TN area 502 (to which the UE is within or is close to).

After transmitting the RRC message including a measurement configuration to the UE, the BS may receive 1542, from the UE, a measurement report including the measurement result about the one or more TN cell 127 in the TN area 502. The network then optionally performs 1560 a hand-over procedure of the UE 102, to the TN cell 127, based on the measurement report received from the UE 102.

FIG. 18 is a flow diagram of a method 1800 that can be implemented by an NTN BS (e.g., BS 104 in this disclosure), for broadcasting the TN carrier frequency and TN area information, and for configuring a UE to measure a TN carrier frequency that is broadcasted in the system information. This method corresponds to the scenario illustrated in FIG. 10. The BS transmits 1804, to the UE, while in the idle state in the NTN cell 124, a system information including a list of carrier frequencies and the TN areas (one or more than one TN areas) associated with each of the carrier frequencies. After the UE transitions to the connected state with the NTN cell 124, the BS transmits 1810, to the UE, an RRC message including a measurement configuration indicating a TN carrier frequency to be measured. In one application, it is possible that step 1810 is repeated multiple times, for each frequency of a TN area if multiple TN areas are sent in step 1804, and each TN area has its own carrier frequency, different from the other TN areas.

After that, the BS may receive 1542, from the UE, a measurement report including the measurement result of the TN carrier frequency to be measured for the given TN area. The network then optionally performs 1560 a hand-over procedure of the UE 102, to the TN cell 127, based on the measurement report received from the UE 102.

The concepts presented in this disclosure have wide-ranging applicability across a diverse spectrum of telecommunication systems, network architectures, and communication standards. For instance, consider the 3GPP, a standards organization responsible for defining numerous wireless communication standards, particularly those related to the evolved packet system (EPS) commonly known as long-term evolution (LTE) networks. Evolved iterations of LTE, like fifth-generation (5G) networks, can support a plethora of services and applications, including but not limited to web browsing, video streaming, Voice over Internet Protocol (VoIP), mission-critical applications, multi-hop networks, real-time remote operations (e.g., tele-surgery), and more.

Hence, the teachings presented here can be implemented across various network technologies, including, but not restricted to, 6G, 5G, fourth-generation (4G), third-generation (3G), and diverse network architectures. Moreover, the techniques described herein can be applied to different types of links, whether it's a downlink, uplink, peer-to-peer link, or any other connection type.

The selection of the specific telecommunication standard, network architecture, or communication standard hinges on the particular application and the overall system design constraints imposed. While these disclosures may illustrate certain aspects in the context of a 6G, 5G or LTE system for clarity, one skilled in the art would recognize that these teachings are equally adaptable to other technological frameworks, networks, components, signaling methods, and so forth.

In summary, the adaptability and versatility of the concepts discussed in this disclosure make them suitable for a wide array of telecommunication scenarios, regardless of the specific terminology or technology involved.

Numerical adjectives “first”, “second”, and “third” used in the above embodiments do not imply any order (are not ordinals) but are markers to distinguish separate instances of similar elements. References to the singular (e.g., “a” or “an”, “the”) should include the plural unless clearly indicated otherwise.

Although the features and elements of the present embodiments are described in the embodiments in particular combinations, each feature or element can be used alone without the other features and elements of the embodiments or in various combinations with or without other features and elements disclosed herein. The methods or flowcharts may be implemented in a computer program, software or firmware tangibly embodied in a computer-readable storage medium for execution by a specifically programmed computer or processor.

1-21. (canceled)

22. A wireless communication method performed by a user equipment, UE, the method comprising:
receiving, from a non-terrestrial network, NTN, base station, BS, a terrestrial network, TN, information message specifying at least one TN area that includes at least one TN cell, the TN information message including a central reference point of the at least one TN area and a distance parameter of the at least one TN area that describes an extent of the TN area relative to the central reference point; and
determining whether the UE is within or close to the at least one TN area.

23. The method of claim 22, further comprising:
transmitting a measurement report indicating a measured parameter of the at least one TN cell only when the UE is within or close to the at least one TN area.

24. The method of claim 22, wherein the TN area includes two or more TN cells.

25. The method of claim 24, wherein the two or more TN cells use a same TN frequency.

26. The method of claim 24, wherein the UE is close to the at least one TN area when the UE is outside the TN area and within an envelope encircling the TN area.

27. The method of claim 22, wherein the UE is in a connected state, via the NTN cell, when receiving the TN information message.

28. The method of claim 22, wherein the TN information message further includes a carrier frequency for measuring the measured parameter of the at least one TN cell.

29. The method of claim 22, wherein the TN information message includes only location information of the at least one TN area, and the method further comprising:
receiving a reconfiguration message with a carrier frequency of the at least one TN cell for measuring the parameter.

30. The method of claim 29, further comprising:
transmitting a proximity indication that identifies the at least one TN area.

31. The method of claim 22, wherein the UE is in an idle state, within a coverage area of an NTN cell of the NTN BS, when receiving the TN information message.

32. The method of claim 31, further comprising:
switching, by the UE, from the idle state to a connected state; and
receiving a reconfiguration message including a carrier frequency associated with the at least one TN cell while in the connected state.

33. The method of claim 32, further comprising:
transmitting a proximity indication that identifies the at least one TN area.

34. The method of claim 31, wherein the TN information message further includes a carrier frequency.

35. The method of claim 22, wherein the TN information message is a radio resource control message or a system information message.

36. A wireless communication method performed by a base station communicating with a user equipment, UE, via a non-terrestrial network, NTN, cell, the method comprising:
transmitting, to the UE, a TN information message specifying at least one terrestrial network, TN, area that includes at least one TN cell, the TN information message including a central reference point of the at least one TN area and a distance parameter of the at least one TN area that describes an extent of the TN area relative to the central reference point; and
initiating a hand-over procedure of the UE to the at least one TN cell based on a received measurement report.

37. The method of claim 36, wherein the TN information message further includes at least a carrier frequency of the at least one TN area.

38. The method of claim 36, further comprising:
receiving, from the UE, a message indicating that the UE is located within or close to the TN area;
transmitting to the UE an additional TN message including a frequency of the at least one TN area; and
receiving from the UE the measurement report.

39. The method of claim 36, further comprising:
receiving, from the UE, a proximity indication that identifies a specific TN area of the at least one TN area.

40. The method of claim 38, wherein the additional TN message is a radio resource control message.

41. The method of claim 36, wherein the TN information is sent via a radio resource control message or a system information message.

42. A wireless communication device comprising:
a transceiver for transmitting commands to a user equipment, UE, and
a processor configured to control the transceiver for
transmitting, to the UE, over a non-terrestrial network, NTN, cell, a terrestrial network, TN, information message specifying at least one terrestrial network, TN, area that includes at least one TN cell, the TN information message including a central reference point of the at least one TN area and a distance parameter of the at least one TN area that describes an extent of the TN area relative to the central reference point; and
initiating a hand-over procedure of the UE to the at least one TN cell based on a received measurement report.
